(19) United States
(12) Patent Application Publication
(10) Pub. No.: US 2010/0241583 A1
(43) Pub. Date: Sep. 23, 2010

(54) RETAINING STATE INFORMATION IN A PUBLISH AND SUBSCRIBE SYSTEM

(75) Inventors: JOSE EMIR GARZA, SURREY (GB); STEPHEN JAMES HOBSON, MIDDLESEX (GB); STEVEN POWELL, WINCHESTER (GB)

Correspondence Address: LAW OFFICE OF JIM BOICE, 3839 BEE CAVE ROAD, SUITE 201, WEST LAKE HILLS, TX, 78746, US

(73) Assignee: INTERNATIONAL BUSINESS MACHINES CORPORATION, ARMONK, NY (US)

(21) Appl. No.: 12/709,586

(22) Filed: Feb. 22, 2010

(30) Foreign Application Priority Data
Mar. 19, 2009 (GB) 09155517.7

(51) Int. Cl. G06Q 10/00; G06Q 50/00

(52) U.S. Cl. 705/344

(57) ABSTRACT

State information in a publish and subscribe system is retained. A state publication is received from a publisher for a topic with one or more delta publications. The state publication and the one or more delta publications are used to keep track of a current state associated with the topic. It is determined that a subscriber has connected to a topic and information pertaining to the current state is sent to the subscriber. This equates to either a list comprising the state publication and subsequent delta publications or a single publication. Such a single publication is maintained by the system and comprises a state publication updated by one or more subsequent delta publications.

### BACKGROUND

1. Field of the Invention

The invention relates to publish and subscribe messaging and more particularly to the retaining of publish and subscribe messages.

2. Description of the Related Art

Publish and subscribe messaging systems (pub/sub systems) are a means of linking programs that generate information (publishers) to programs that process that information (subscribers), without requiring either set of programs to be aware of the other. That is, “messages” (formatted information) are published under “topics” to a messaging system and subscribers register their interest in certain topics with the messaging system.

When a message is published under a topic, the message is sent by the pub/sub system to all subscribers that are currently registered for that topic. The only common knowledge required is the topic name (and the shared pub/sub system).

Such a system is particularly advantageous because publishers do not need to know which, or how many, subscribers there are, nor do subscribers have to know the source of the message information.

Enhancements to the basic system include the notion of a “retained publication.” This means that associated with each topic is the last publication that was published to that topic. Subscribers who register an interest in a topic that has a retained publication will receive that publication immediately, and, thereafter, whatever is further published, as usual. This provides partial support for late subscribers, or subscribers who wish to disconnect and reconnect to the messaging system, allowing a limited form of (re)initialization to be performed by the subscriber.

An overview of a pub/sub system is provided at http://publib.boulder.ibm.com/infocenter/wmbhelp/v6r0m0/topic/com.ibm.etools.mft.doc/aq0 1120_.htm, and is incorporated herein by reference.

One of the common uses of pub/sub systems involves the maintenance of (potentially large) state information by publication of deltas or updates. Although the initial state might be large (contains a large amount of information and can be quite extensive), the updates are likely to be small by comparison. The subscribers start with an agreed state and receive updates as and when they are published.

In long-lived systems, subscribers come and go and require a means of initialization, so as to interpret the stream of deltas they will receive after registration.

One possible option is for a new subscriber to communicate with the publisher by some other means (other than by using the pub/sub system) and state information is sent by the publisher to enable a subscriber to ‘catch up.’ This is initialization upon demand. This spoils the basic advantages of the pub/sub system—the publisher and subscriber need knowledge of each other—and creates difficulty in synchronising the state and the delta sequence.

### BRIEF SUMMARY

According to an embodiment, the invention provides a method for retaining state information in a publish and subscribe system, comprising: receiving for a topic, a state publication and one or more delta publications, from a publisher; using the state publication and the one or more delta publications to keep track of a current state associated with the topic; determining that a subscriber has connected to the topic; and sending information pertaining to the current state to the subscriber.

According to an embodiment, there is provided a computer system for retaining state information in a publish and subscribe system, comprising: a processor programmed to receive a topic, a state publication, and one or more delta publications from a publisher; use the state publication and the one or more delta publications to keep track of a current state associated with the topic; determine that a subscriber has connected to the topic; and send information pertaining to the current state to the subscriber.

According to an embodiment, a computer program product retains state information in a publish and subscribe system. The computer program product comprises a computer readable storage medium having computer readable program code embodied therewith. The computer readable program code comprises: computer readable program code configured to receive for a topic a state publication and one or more delta publications from a publisher; computer readable program code configured to use the state publication and the one or more delta publications to keep track of a current state associated with the topic; computer readable program code configured to determine that a subscriber has connected to the topic; and computer readable program code configured to send information pertaining to the current state to the subscriber.

### BRIEF DESCRIPTION OF THE SEVERAL VIEWS OF THE DRAWINGS

FIG. 1 illustrates a publish and subscribe messaging system in accordance with the prior art;

FIGS. 2A and 2B illustrate an overview of the processing of the present invention in accordance with a first embodiment; and

FIGS. 3A and 3B illustrate an overview of the processing of the present invention in accordance with a second embodiment.

### DETAILED DESCRIPTION

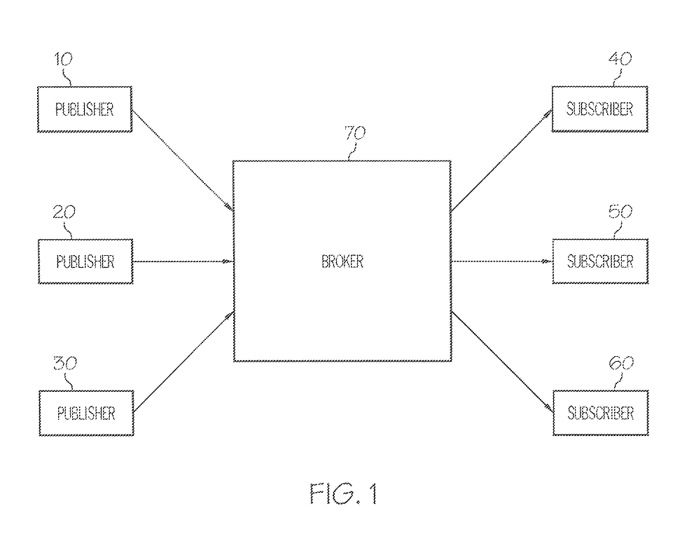

An overview of a typical pub/sub system, e.g. IBM® WebSphere® Message Broker (IBM and WebSphere are trademarks of IBM Corp. in the U.S., other countries, or both), is described with reference to FIG. 1. Such a system comprises a number of publishers 10, 20, and 30 publishing messages to a broker 70 on particular topics (e.g. news, weather, sport). Subscribers 40, 50, and 60 register their interest in such topics via subscription requests received at the broker 70. For example, subscriber 40 may request to receive any information published on the weather topic, while subscriber 50 may desire information on the news and sports.

When broker 70 receives a message on a particular topic from a publisher, the broker determines from its list of subscriptions to which that message should be sent. The broker then transmits the message to such subscribers.

Thus, the key advantage of publish and subscribe is clearest when considering messaging between a large set of publishers and a large set of subscribers. With publish and subscribe, because messages are delivered to each matching subscriber, no pre-configuration of message routing is required. Instead, all applications can connect to a single well-known publish and subscribe destination, which provides a “broker” capability, matching each consumer's subscription request to the messages produced.

As discussed above, the set of subscribers attached to a broker may be continually changing. By default, a message broker discards a publication after it has been sent to all parties associated with the topic on which the publication has been received. If a new subscriber subsequently registers with that same topic (or an old subscriber re-connects), they must wait for a new message to be published. No previous information is available to them.

A retained publication system however retains the last message published on each topic. A retained publication is therefore immediately sent out to subscribers who subsequently connect to the topic.

As previously mentioned, some pub/sub systems publish both state information and deltas on top of any base state (state/delta systems). For example in the airline industry, a publisher may publish a message containing all the flight arrival information for the day. This is termed a state publication. If any changes subsequently occur, for example, a flight is cancelled, the publisher would issue a delta publication detailing just the change.

Just as with a system coping with self-contained information only, it may be desirable for re-connecting or new subscribers to receive (upon connection) information previously published on the topic. With current systems, only one publication per topic is retained and this modus operandi does not easily translate to use by state/delta systems. State publications will typically be published infrequently with deltas being published often. It would therefore very much depend when a subscriber connected as to how useful any received information is. If the retained publication on a topic happens to be a state publication, then this will be useful to them. However if it is a delta, it is likely to be of less use since the subscriber won't have the associated base state information which forms the basis for the delta.

This solution therefore extends the notion of retained publications to systems which publish both state and delta information.

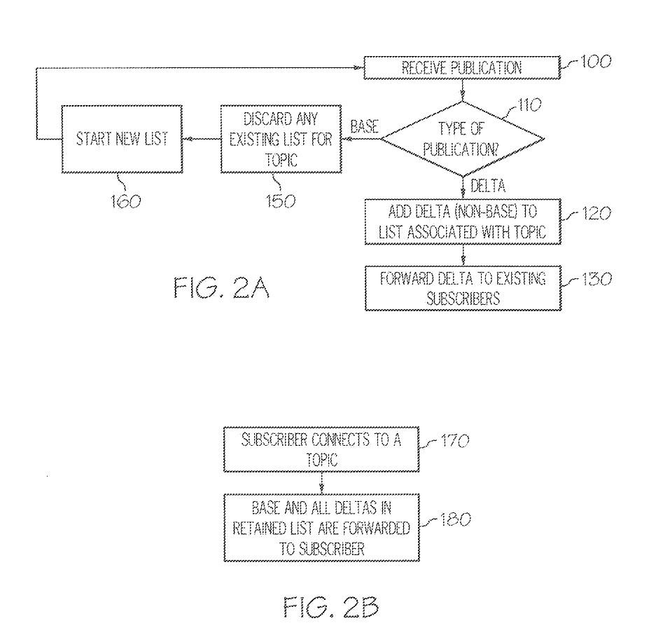

FIGS. 2a and 2b illustrate an overview of the processing of the present invention in accordance with an embodiment of the invention. Instead of retaining a single message on each topic, a pub/sub system is augmented to allow a sequence of messages to be retained against a single topic. This is called a ‘retained list.’ The first in the sequence is designated the ‘base’ of the list and comprises state information. Subsequent messages in the list are delta updates to the base state publication.

Thus, the publisher can publish two types of retained messages on a topic: a retained base message (state information) and a retained non-base message. A retained non-base message comprises delta information.

At step 100, a publication is received by the message broker. It is then determined at step 110 whether the publication has been designated by its publisher to be a base retained message or a non-base retained message. Each time a base is published any existing retained list on that topic is discarded (step 150) and a new-one is accrued, starting with the base (step 160). All subsequent (non-base) publications are saved at step 120 as part of the list (in order of publication). Delta publications are also forwarded to existing subscribers at step 130. Step 130 may happen in parallel with step 120.

It should be noted that when a retained base message is published, the pub/sub system does not send it to existing subscribers, but only saves it (starting a new list). An exception to this is if a retained list is not already associated with the topic, in which case existing subscribers will need to be informed of the publication. When a retained non-base message is published it is sent to all existing subscribers (as usual).

Periodically, the publisher preferably publishes a new base message, which records the current state and which replaces the retained list. The publisher can then publish deltas as usual.

FIG. 2b shows, in accordance with an embodiment, the processing that occurs when a subscriber re-connects to a topic or registers a new interest in a topic at step 170. At step 180, the subscriber receives all the messages in the current ‘retained list’ for that topic, including and starting with the base. The new subscriber thus receives a series of messages comprising the base message and an ordered sequence of delta messages.

By this means, the pub/sub system retains the current state, periodically sent by the publisher, and also manages a series of deltas (which are modifications to the state)—in the correct sequence. A subscriber registers to the single topic and receives an initial state, followed by deltas from then on.

Thus, subscribers do not have to make special arrangements to initialize if they register (or re-register) after the publisher commences. The initial state information is consistent with the subsequent deltas without special action. In addition, state is not propagated to all subscribers whenever it is published (it is propagated to new or re-connecting subscribers who need it), and there is still no need for the publisher and subscribers to directly communicate, or to account for one another, even temporarily.

There is possibly a need for a publisher to start again, and so there is preferably an option for the base publication to be ‘forced’ to all existing subscribers. This will provide a mechanism for publishers to ‘resynchronise’ all subscribers, if necessary.

Having provided an overview of an embodiment, more detail will be provided by reference to the “publication” message and functions of the IBM WebSphere Message Broker software. The current publication message parameters and options are augmented with new options, and a modified description is detailed.

The command to publish is MQPSC_PUBLISH and this command can take a number of options <PubOpt>. The publication options property can, in accordance with the first embodiment, take the following values:

RetainPub (MQPSC_RETAIN_PUB)

The broker is to retain a copy of the publication. In accordance with an embodiment, this is a single retained publication, or, if a BasePub (see below) publication has been published and retained, the next publication is a retained list. If this option is not set, the publication is deleted after processing.

Base (MQPSC_BASE)

If there is a retained list for this topic, the broker is to remove the existing retained list and replace it with this single (base) publication. The publication is not sent to current subscribers. If there is no retained list, then this publication forms the base of a new retained list and the publication is sent to current subscribers. (This publication is retained only if the RetainPub option is specified, otherwise it is deleted. If it is the base of a (new) retained list, then the old retained list is discarded also. This is the means by which a retained list may be discarded once a new one has been created.)

IsRetainedPub (MQPSC_IS_RETAINED_PUB)

This can only be set by a broker. This publication has been retained by the broker. The broker sets this option to notify a subscriber that this publication was published earlier and has been retained, provided that the subscription has been registered with the InformIfRetained (see below) option. It is sent only in response to a Register Subscriber or Request Update command message. Retained publications that are sent directly to subscribers do not have this option set.

All publications in a retained list are sent to a subscriber in response to Register Subscriber or Request Update. If the subscription is registered with the InformIfRetained option each of these publications will have the IsRetainedPub option set, including the first (base) publication which will also have the IsBasePub option set.

IsBasePub (MQPSC_IS_BASE_PUB)

This can only be set by a broker. This publication has been retained by the broker and is the base (first) publication of a retained list. The broker sets this option to notify a subscriber provided that the subscription has been registered with the InformIfRetained option. It is sent only in response to a Register Subscriber or Request Update command message. Retained publications that are sent directly to subscribers do not have this option set. A Request Update command message is used by a re-connecting subscriber to receive the last retained publication associated with any topics that they have registered an interest in.

All publications in a retained list are sent in response to a Register Subscriber or Request Update command message. Each of these will have the IsRetainedPub option set, including the first (base) publication which will also have the IsBasePub option set.

The broker behaviour in response to the publish message is indicated in the (modified) description above, but the details, where they differ from existing function, are described again below.

Topic and Publication State

A topic may have a retained publication, a retained list, or neither. It cannot have both. A retained publication is a single publication; a retained list is an ordered list of one or more publications, the first being called the base publication. A publication can have neither, one or both of the options Base and RetainPub set.

Subscribe

When a new subscriber sends a subscription to the message broker for a topic (or a Request Update message is sent from an existing subscriber), if the topic has a retained list the entire list is sent as a series of individual publications to the subscriber—including the first (base) publication of the list. These are sent in strict order, starting with the base publication. No other publications are sent to the subscriber until this list is sent. The retained list is preserved.

If the new (or existing) subscription has the InformIfRetained option set, then the options IsBasePub and IsRetainedPub are set on the base publication, and IsRetainedPub is set on all the other publications in the list (for that subscription).

If the topic has a retained publication it is sent to the new subscriber, as usual. This is consistent with existing function.

If the topic has neither a retained publication nor a retained list, no publications are sent in response to a new subscription. This is consistent with existing function.

This is summarised in the following table:

| Subscribe action | Subscription state | |
|---|---|---|
| Topic state | InformIfRetained set | InformIfRetained not set |
| no retained publication | no publications sent | no publications sent |
| and no retained list | | |
| retained publication | retained publication sent, | retained publication sent |
| | marked IsRetainedPub | |
| retained list (b, p₁, p₂, . . . , | send (b, p₁, p₂, . . . , pₙ) to new | send (b, p₁, p₂, . . . , pₙ) to |
| pₙ) | subscriber, in that order; b is | new subscriber, in that |
| | marked IsBasePub and | order |
| | IsRetainedPub; p₁, p₂, . . . , pₙ | |
| | are all marked IsRetainedPub | |

Publish

A publication can have the RetainPub option set or not. If the RetainPub option is set, then when the publication is received at the broker, it is retained.

It can have the Base option set or not. If the Base option is set the message can form the base of a new retained list. The broker discards any existing retained list, or any existing retained publication. Nothing is sent to existing subscribers unless there was no existing retained list to discard. If there was no retained list discarded then this publication is sent to all existing subscribers for this topic.

If the Base option is not set, the publication is sent to existing subscribers.

The combined effect of these rules applies when both Base and RetainPub options are set: the publication is not sent to existing subscribers, and the publication is retained as the base publication of a new retained list. Any existing retained list or retained publication is discarded.

These actions are described in full in the following table:

| | | state | | |
|---|---|---|---|---|
| | Publication p | | | Base not set and |
| Publish action | Base and | | RetainPub | RetainPub not |
| Topic state | RetainPub set | Base set only | set only | set |
| No retained | retained list set to | send p to | send p to | send p to existing |
| publication and | (p); send p to | existing | existing | subscribers (topic |
| no retained list | existing | subscribers | subscribers | state unchanged) |
| | subscribers | (topic state | (save p as | |
| | | unchanged) | retained | |
| | | | publication) | |
| retained | retained list set to | send p to | send p to | send p to existing |
| publication | (p); discard | existing | existing | subscribers |
| | retained | subscribers | subscribers | (retained |
| | publication; send | (discard | (save p as | publication |
| | p to existing | retained | retained | unchanged; |
| | subscribers | publication in | publication) | consistent with |
| | | order to reset | | existing |
| | | the topic state | | behaviour) |
| | | to no retained | | |
| | | publication | | |
| | | and no | | |
| | | retained list) | | |
| retained list (b, | retained list set to | retained list | retained list | send p to existing |
| p₁, p₂, . . . , pₙ) | (p); no | discarded; no | set to (b, p₁, | subscribers |
| | publications sent | publications | p₂, . . . , pₙ, p); | (retained list |
| | to existing | sent to | send p to | unchanged) |
| | subscribers | existing | existing | |
| | | subscribers | subscribers | |

The scheme as described above has the property that a publisher can publish both event (update or delta) publications and state (initial) publications, without having to worry about existing or future subscribers missing the state (initial) publications or delta publications or receiving them in the wrong order. No special communication mechanism is required to permit a subscriber to resynchronize or to re-initialize state if it subscribes before or after a publisher publishes state and deltas to a state.

The scheme described uses the publish and subscribe broker to store the publications in a retained list for each topic. The state publication and the delta (event) publications can be stored close to the publisher in a cooperating set of brokers supplying a single publish and subscribe space for many subscribers. This means that state publications (which are not sent to existing subscribers normally) can be relatively inexpensive to publish, even though they may be relatively large compared to delta (event) publications. Thus, network traffic for state publications is reduced to only those subscribers that need it.

In the solution outlined above, the broker is not aware of the relationship between the deltas and the state, in particular, it is not capable of applying a delta to a state publication to derive a new state publication. This is because the data organisation is not public knowledge. In general this is only understood by the producing and consuming applications.

In a special case, for example, when the delta messages use a format which complies with a known public standard, then, by prior agreement, the broker can maintain the state by applying deltas to a state publication.

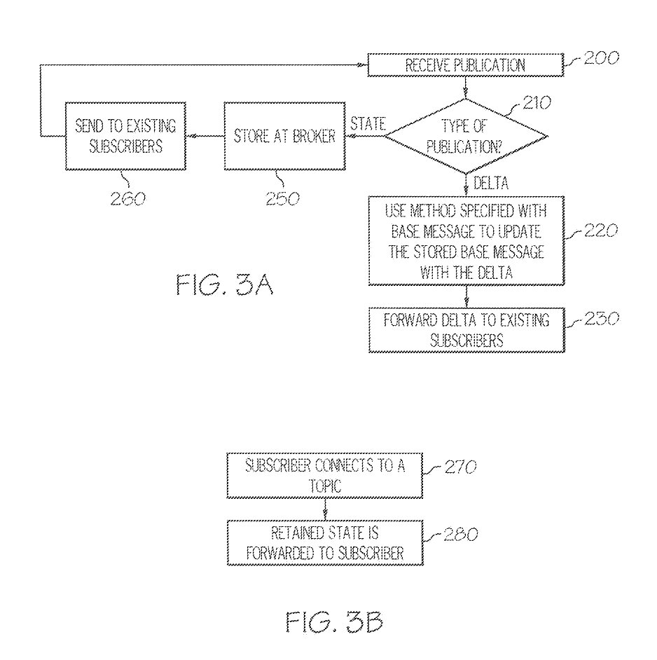

An overview of this process is described with reference to FIGS. 3a and 3b. A publication is received by the message broker at step 200. It is determined what type of publication has been received at step 210. If it is a state publication, then this is stored at the broker (step 250) as state information (any prior retained state information may be replaced by new state information). This publication is forwarded en to existing subscribers at step 260.

If the publication is a delta, then the delta is used to update stored state information associated with the topic on which the message was published. The method specified when the original state publication was sent is used to transform the state information in accordance with the delta publication. By way of example, if the delta messages use a format which complies with XSLT then, by prior agreement, the broker can maintain the state by applying the XSLT delta using a standard XSLT engine. Therefore, in this case in which the application and message broker share the data format and transformation technology, an optimization can be achieved as follows:
The publisher first publishes the state in XML to a complicit broker. It identifies this as the state information. Subsequent subscribers will receive this in the way described above.
Thereafter the publisher publishes XSLT deltas, and the broker applies them to its copy of the state before sending them to existing subscribers. The new state is available to subsequent subscribers as usual.

It should be appreciated that the transformation method does not have to be specified as part of the original state message. The broker might determine the method by some other means. For example, it might be specified in a registry.

The principal idea, therefore, is for the broker to maintain the state and to supply the (always up-to-date) state to any new (or refreshed) subscribers, while passing updates (events) received from the publisher(s) to existing subscribers and at the same time updating its own retained state. If the broker maintains the state for itself, the publisher need not re-publish the state, the state need not be promulgated to any except to new subscribers (and/or re-connecting subscribers), and the storage required by the broker is reasonably static, requiring no ‘reset’ by the publisher.

As indicated above, this mechanism requires that the description of the state, and updates to the state, be in a form agreed upon by publishers, the broker, and the subscribers. A typical publisher would publish the state, together with an indication of the form (protocol) used to keep the state up-to-date, and, thereafter, publish (on that same topic) events (or deltas) to the state in the agreed protocol.

The broker preferably retains the state for a ‘retained state’ publication, together with an indication of the update protocol. When an update publication is submitted, it applies the update to its retained state, and publishes the update (unchanged) to any existing subscribers.

If a new subscriber connects to the topic, the broker, preferably, immediately, sends a copy of the (current) state to the subscriber before sending any (further) update publications.

A subscriber preferably subscribes to the topic and processes the first publication received as the (initial) state of the topic, thereafter, receiving only update publications. The update publications continue until either the subscriber removes the subscription, or until the publisher resets the retained state. The nature of the publication received by the subscriber is determinable from the publication flags (see below) so a subscriber can always tell if re-initialization is required.

Thus, the initialization problem is resolved without requiring heavy storage overheads in the broker, and requiring little or no modifications to the publisher and subscriber protocols that existing applications use. It reduces the need to publish the state periodically, and eliminates the need to synchronize initial (state) data with other (event) data from a different source.

Therefore, the publisher need not periodically publish the state (though it may choose to do so at any time). The broker need not store a list of updates but retains the synchronization of the state and delta message flow for the subscribers, and the subscriber only receives a single state message after it subscribes.

The standard publication messages and parameters are augmented with new options and a modified description:

RetainPub (MQPSC_RETAIN_PUB)

The broker is to retain a copy of the publication. (This is a single retained publication or, if there is a retained state and the State (MQPSC_STATE) option is not set, the transformation publication is to be applied to the retained state.) If this option is not set, the publication is deleted after processing.

State (MQPSC_STATE)

If there is a retained state for this topic the broker removes the existing retained state and replaces it with this (State) publication. The publication is sent to current subscribers.

If there is no retained state then this publication forms the new retained state. The publication is sent to current subscribers.

(This publication is retained only if the RetainPub option is specified, otherwise it is deleted. If it is a (new) retained state, then the retained state is discarded also. This is the means by which the retained state may be discarded once it has been created on a topic. The topic state then becomes ‘no retained publication and no retained state’—see the table below.) The <RetainedTransformationMethed> value is specified with this publication (see below).

IsRetainedPub (MQPSC_IS_RETAINED_PUB)

This can only be set by a broker. This publication has been retained by the broker. The broker sets this option to notify a subscriber that this publication was published earlier and has been retained, provided that the subscription has been registered with the InformIfRetained option. It is sent only in response to a Register Subscriber or Request Update command message. Retained publications that are sent directly to subscribers do not have this option set.

The retained state is sent to a subscriber in response to Register Subscriber or Request Update. If the subscription is registered with the InformIfRetained option this publication will have the IsRetainedPub option set, and the IsStatePub option set.

IsStatePub (MQPSCIS_STATE_PUB)

This can only be set by a broker. This publication has been retained by the broker and is a State (retained state) publication. The broker sets this option to notify a subscriber provided that the subscription has been registered with the InformIfRetained option. It is sent only in response to a Register Subscriber or Request Update command message. Retained publications (or update publications) that are sent directly to existing subscribers do not have this option set.

<RetainedTransformationMethod>

(MQPSC_RETAINED_TRANSFORMATION_METHOD)

A string identifying one of an agreed set of transformation methods, for example “XSLT”, or “ESQL”. This should be specified if a State of a retained state publication is published. The presence of this parameter indicates that this publication on this topic forms the base state, and all subsequent publications (without this parameter) are deltas to the state, using the given transformation method.

When this parameter is specified the publication option State must also be specified. All subsequent publications on this topic are assumed to be transformation deltas unless State is specified.

The broker behaviour in response to the publish message is indicated in the (modified) description text against the options in the publish message augmentation, but the details, where they differ from existing function, are described again here.

Topic and Publication State

A topic may have a retained publication, a retained state, or neither. It cannot have both. A retained publication is a single publication; a retained state is an update-managed retained publication. A publication can have neither, one, or both of the options State and RetainPub set.

Subscribe

When a new subscriber sends a subscription to the pub/sub system for a topic (or a Request Update message is sent from an existing subscriber), if the topic has a retained state, the (State) state is sent to the subscriber. No other publication on this topic is sent to the subscriber until this is sent. The retained state is preserved.

If the new (or existing) subscription has the InformIfRetained option set, then the options IsStatePub and IsRetainedPub are set on the state publication. If the topic has a retained publication it is sent to the new subscriber, as usual. If the topic has neither a retained publication nor a retained state, no publications are sent in response to a new subscription.

This is described in the following table:

| | Subscription state | |
|---|---|---|
| Subscribe action | | InformIfRetained |
| Topic state | InformIfRetained set | not set |
| no retained publication | no publications sent | no publications |
| and no retained state | | sent |
| retained publication | retained publication sent, | retained publication |
| | marked IsRetainedPub | sent |
| retained state | send retained state to new | send retained state |
| | subscriber marked | to new subscriber |
| | IsStatePub and | |
| | IsRetainedPub | |

Thus, retained state and a retained publication are treated exactly the same, except that the IsStatePub option is set in a retained state.

Publish

When a publication is sent to the broker for a topic, it can have the State option set or not. If the State option is set the message can form a new retained state. The broker discards any existing retained state, or any existing retained publication. This publication is sent to all existing subscribers for this topic.

If the State option is not set the publication is sent to existing subscribers.

A publication can also have the RetainPub option set, or not. If the RetainPub option is set, then the publication is either retained as is or applied to a retained state. If this publication forms a (new) retained state (see the State option), it is retained as is. If it is not a new retained state (the State option is not set), and there is retained state already, this is used to update the retained state (using the transformation protocol indicated in the <RetainedTransformationMethod> property). If there is no retained state, it replaces (or creates) the retained publication as at present.

If the RetainPub option is not set, this publication is not retained.

These actions are described in full in the following table:

| | | state | | |
|---|---|---|---|---|
| | Publication p | | | State not set |
| | State and | | | and |
| Publish action | RetainPub | State set | RetainPub | RetainPub |
| Topic state | set | only | set only | not set |
| no retained | retained state | send p to | send p to | send p to |
| publication and | set to (p); | existing | existing | existing |
| no retained | send p to | subscribers | subscribers | subscribers |
| state | existing | (topic state | (save p as | (topic state |
| | subscribers | unchanged) | retained | unchanged) |
| | | | publication) | |
| retained | retained state | send p to | send p to | send p to |
| publication | set to (p); | existing | existing | existing |
| | discard | subscribers | subscribers | subscribers |
| | retained | (discard | (save p as | (retained |
| | publication; | retained | retained | publication |
| | send p to | publication) | publication) | unchanged) |
| | existing | | | |
| | subscribers | | | |
| retained state | retained state | retained state | retained state | send p to |
| (b) | set to (p); | discarded; | set to (b | existing |
| | send p to | send p to | transformed | subscribers |
| | existing | existing | by p); send p | (retained |
| | subscribers | subscribers | to existing | state |
| | | | subscribers | unchanged) |

The scheme as described above has the property that a publisher can publish both event (update or delta) publications and state (initial) publications, without having to worry about existing or future subscribers missing the state (initial) publications, delta publications, or receiving them in the wrong order. No special communication mechanism is required to permit a subscriber to resynchronise or to re-initialize state if it subscribes before or after a publisher publishes state and deltas to a state.

The presence of the <RetainedTransformationMethod> parameter indicates that a publication on this topic forms the state, and all subsequent publications (without this parameter) are deltas to the state, using the given transformation method.

The scheme described uses the publish and subscribe broker to store the state (retained state) for each topic. This has bounded cost in storage and allows the state to be stored close to the publisher in a cooperating set of brokers supplying a single publish and subscribe space for many subscribers. It also allows state publications to be virtually eliminated for the publisher, and reduced to only those subscribers who come late to the topic. Thus network traffic for state publications is reduced to only those subscribers that need it.

To summarize, the two solutions above do not impair but rather augment existing pub/sub functionality. It should be appreciated that the two solutions have different responsibilities for both the publisher and the subscriber. With regard to the publisher, the first solution has to manage the periodic publication of state information, while the second solution does not. With regard to the subscriber, the first solution means that a sequence of messages is typically provided upon subscription (a state message followed by one or more deltas). This is not the case with the second solution, where the subscriber receives only one message containing the most up to date information (as maintained by the broker).

Note the claims below refer to a state publication. In one embodiment this is referred to as a base publication. In another embodiment this is a State publication (retained state).

1. A method for retaining state information in a publish and subscribe system, comprising:
receiving for a topic a state publication and one or more delta publications from a publisher;
using the state publication and the one or more delta publications to keep track of a current state associated with the topic;
determining that a subscriber has connected to the topic; and
sending information pertaining to the current state to the subscriber.

2. The method of claim 1, wherein using the state publication and the one or more delta publications to keep track of a current state comprises:
compiling a list including the state publication and one or more delta publications, and wherein sending information pertaining to the current state to subscriber comprises sending the compiled list to the subscriber.

3. The method of claim 2, comprising:
periodically receiving a new state publication; and
discarding the previously compiled list.

4. The method of claim 3, comprising:
sending the new state publication to existing subscribers.

5. The method of claim 4, comprising:
sending delta publications to existing subscribers upon receipt.

6. The method of claim 1, wherein the step of using the state publication and one or more delta publications to keep track of a current state comprises:
retaining the received state publication; and
modifying the received state publication with each received delta publication in order to create a current state publication, and wherein sending information pertaining to the current state to the new subscriber comprises sending the created current state publication to the subscriber.

7. The method of claim 6, wherein the step of modifying the received state publication with each received delta publication comprises:
using a method specified by the publisher to modify the received state publication with a received delta.

8. The method of claim 7, comprising:
sending each delta publication upon receipt to existing subscribers.

9. The method of claim 8, comprising:
responsive to determining that a received message is a state publication, sending the state publication to existing subscribers.

10. A computer system for retaining state information in a publish and subscribe system, comprising a processor programmed to:
receive a topic, a state publication, and one or more delta publications from a publisher;
use the state publication and the one or more delta publications to keep track of a current state associated with the topic;
determine that a subscriber has connected to the topic; and
send information pertaining to the current state to the subscriber.

11. The computer system of claim 10, wherein the processor programmed to use the state publication and the one or more delta publications to keep track of a current state is further programmed to:
compile a list including the state publication and one or more delta publications,
and wherein the processor programmed to send information pertaining to the current state to the subscriber is further programmed to:
send the compiled list to the subscriber.

12. The computer system of claim 11, wherein the processor is further programmed to:
periodically receive a new state publication; and
discard the previously compiled list.

13. The computer system of claim 12, wherein the processor is further programmed to:
send the new state publication to existing subscribers.

14. The computer system of claim 13, wherein the processor is further programmed to:
send delta publications to existing subscribers upon receipt.

15. The computer system of claim 10, wherein the processor programmed to use the state publication and one or more delta publications to keep track of a current state is further programmed to:
retain the received state publication; and
modify the received state publication with each received delta publication in order to create a current state publication,
and wherein the processor programmed to send information pertaining to the current state to the new subscriber is further programmed to:
send the created current state publication to the subscriber.

16. The computer system of claim 15, wherein the processor programmed to modify the received state publication with each received delta publication is further programmed to:
use a method specified by the publisher to modify the received state publication with a received delta.

17. The computer system of claim 16, wherein the processor is further programmed to:
send each delta publication upon receipt to existing subscribers.

18. A computer program product for retaining state information in a publish and subscribe system, the computer program product comprising a computer readable storage medium having computer readable program code embodied therewith, the computer readable program code comprising:
computer readable program code configured to receive for a topic a state publication and one or more delta publications from a publisher; and
computer readable program code configured to use the state publication and the one or more delta publications to keep track of a current state associated with the topic;
computer readable program code configured to determine that a subscriber has connected to the topic; and
computer readable program code configured to send information pertaining to the current state to the subscriber.

19. The computer program product for retaining state information in a publish and subscribe system of claim 18, wherein the computer readable program code configured to use the state publication and the one or more delta publications to keep track of a current state is further configured to:
compile a list including the state publication and one or more delta publications, and wherein the computer readable program code configured to send information pertaining to the current state to the subscriber is further configured to:
send the compiled list to the subscriber.

20. The computer program product for retaining state information in a publish and subscribe system of claim 19, wherein the computer readable program code is further configured to:
periodically receive a new state publication; and
discard the previously compiled list.

21. The computer program product for retaining state information in the publish and subscribe system of claim 20, wherein the computer readable program code is further configured to:
send the new state publication to existing subscribers.

22. The computer program product for retaining state information in the publish and subscribe system of claim 21, wherein the computer readable program code is further configured to:
send delta publications to existing subscribers upon receipt.

23. The computer program product of claim 18, wherein the computer readable program code configured to use the state publication and the one or more delta publications to keep track of a current state associated with the topic is further programmed to:
retain the received state publication; and
modify the received state publication with each received delta publication in order to create a current state publication,
and wherein the computer readable program code configured to send information pertaining to the current state to the new subscriber is further programmed to:
send the created current state publication to the subscriber.

24. The computer program product of claim 23, wherein the computer readable program code configured to modify the received state publication with each received delta publication is further configured to:
use a method specified by the publisher to modify the received state publication with a received delta.

25. The computer program product of claim 24, wherein the computer readable program code is further configured to:
send each delta publication upon receipt to existing subscribers.
